(19) United States
(12) Patent Application Publication
(10) Pub. No.: US 2022/0104465 A1
(43) Pub. Date: Apr. 7, 2022

(54) TREATMENT RESERVOIRS AND SYSTEMS FOR CONTROLLED RELEASE OF A TREATMENT COMPOUND IN AN AQUATIC ENVIRONMENT

(71) Applicant: W. L. Gore & Associates, Inc., Newark, DE (US)

(72) Inventors: Shaun M. Leone, Flagstaff, AZ (US); Alexis N. Slupe, Flagstaff, AZ (US)

(21) Appl. No.: 17/430,945

(22) PCT Filed: Feb. 13, 2020
(86) PCT No.: PCT/US2020/018134

§ 371 Date: Aug. 13, 2021

Related U.S. Application Data
(60) Provisional application No. 62/805,620, filed on Feb. 14, 2019.

(51) Int. Cl. A01K 61/13; A01K 63/04; A01K 61/60

(52) U.S. Cl. CPC A01K 61/13; A01K 61/60; A01K 63/04

(57) ABSTRACT

The present disclosure relates generally to treatment reservoirs (155, 250, 260, 370) for delivering treatment compounds to an aquatic environment and systems configured for controlled release of a treatment compound in an aquatic environment. The present disclosure provides a treatment reservoir including a treatment compound and a delivery apparatus configured to release the treatment compound according to a desired release profile. The delivery apparatus may include a release media operatively associated with the treatment compound such that the release media is configured to release the treatment compound to the aquatic environment according to the desired release profile. The present disclosure further provides containment pens (115) and containment systems for containing aquatic organisms in an aquatic environment including at least one treatment reservoir including a treatment compound and a delivery apparatus operatively associated with the treatment compound to release the treatment compound to the aquatic environment according to a desired release profile.

### CROSS-REFERENCE TO RELATED APPLICATION

This application is a national phase application of PCT Application No. PCT/US2020/018134, internationally filed on Feb. 13, 2020, which claims the benefit of U.S. Provisional Application No. 62/805,620, filed Feb. 14, 2019, both of which are herein incorporated by reference in their entireties for all purposes.

### BACKGROUND

Methods of reducing sea lice infestation of fish by incorporating treatment compounds into fish feed, bathing fish in chemicals or medicines, or physical removal are known. However, conventional treatment compounds are undesirable as they may affect the safety, health, wellness, as well as the taste of the fish later being sold to market as food. To limit the population growth of parasites that results from the successful attachment and mating of parasites (e.g. lice) to fish in aquaculture pens, deterrents, repellants, and/or masking compounds need to be transmitted over the period of viability. The viable season peak may be four months or longer. As such, there is a need to provide a controlled release of treatment compounds to effectively deter, reduce, or eliminate parasite populations in fish farm environments while not affecting the quality, taste, safety, or yield of the fish that will be harvested for food. Additionally, there is a need to provide a release media that is effective to release the treatment compounds via diffusion in sea conditions as needed and at the desired release profile.

### SUMMARY

According to one example (“Example 1”), a treatment reservoir for delivering a treatment compound to an aquatic environment includes a treatment compound, and a delivery apparatus configured to release the treatment compound according to a desired release profile, wherein the delivery apparatus is operatively associated with the treatment compound and is configured to release the treatment compound to the aquatic environment according to a desired release profile.

According to another example (“Example 2”), further to Example 1, the delivery apparatus includes a release media configured to release the treatment compound from the delivery apparatus to the aquatic environment according to the desired release profile.

According to another example (“Example 3”), further to Example 2, the release media is in a form selected from a membrane, a sheet, a tube, a bladder, a fiber, a coating, and a combination thereof.

According to another example (“Example 4”), further to Examples 2 or 3, the release media comprises at least one of a fluoropolymer, a polyethylene, a polypropylene, polyvinylidene fluoride, polyurethane, nylon, nitrocellulose, and polyethersulfone.

According to another example (“Example 5”), further to Examples 2-4, the release media includes a microporous polyethylene and/or an expanded polyethylene.

According to another example (“Example 6”), further to Example 4, the fluoropolymer is an expanded polytetrafluoroethylene (ePTFE).

According to another example (“Example 7”), further to Examples 2-6, the release media further includes at least one coating.

According to another example (“Example 8”), further to Example 7, the at least one coating is semi-permeable.

According to another example (“Example 9”), further to Examples 7 or 8, the at least one coating includes at least one thermoplastic polymer, at least one fluoropolymer, or a combination thereof.

According to another example (“Example 10”), further to Example 9, the at least one thermoplastic polymer is selected from: polyethylene, polypropylene, polyvinyl chloride, polystyrene, polybenzimidazole acrylic, nylon, polytetrafluoroethylene (PTFE), poly(ethene-co-tetrafluoroethene) (ETFE), polyvinylidene difluoride (PVDF), polychlorotrifluoroethylene (PCTFE), fluorinated ethylene propylene (FEP), perfluoroalkoxy (PFA), polyurethane (PUR), a nitrocellulose (NC), a polyethersulfone, and combinations thereof, and the at least one fluoropolymer is selected from: poly(ethene-co-tetrafluoroethene) (ETFE), polytetrafluoroethylene (PTFE), polyvinylidene difluoride (PVDF), polychlorotrifluoroethylene (PCTFE), fluorinated ethylene propylene (FEP), and combinations thereof.

According to another example (“Example 11”), further to Examples 2-10, the delivery apparatus comprises a container having at least one port, wherein the container contains the treatment compound and the at least one port includes the release media.

According to another example (“Example 12”), further to Examples 2-10, the treatment reservoir further includes an outer containment vessel configured to retain the delivery apparatus, wherein the outer containment vessel includes a plurality of openings and the delivery apparatus comprises a delivery bladder at least partially formed from the release media.

According to another example (“Example 13”), further to Example 12, the delivery bladder is a sealable tube or an injectable bladder.

According to another example (“Example 14”), further to Example 12 or Example 13, the outer containment vessel is cylindrical and includes an end cap at each end of the cylindrical containment vessel, wherein each end cap is configured to engage the outer containment vessel.

According to another example (“Example 15”), further to Examples 12-14, the treatment reservoir further includes one or more attachment devices configured to retain the outer containment vessel in position.

According to another example (“Example 16”), further to Examples 2-15, the treatment compound is diffusible through the release media.

According to another example (“Example 17”), further to Examples 1-16, the treatment compound is selected from a semiochemical compound, an antiparasitic compound, a masking compound, a baiting compound, and combinations thereof.

According to another example (“Example 18”), further to Examples 1-17, the treatment compound is selected from: 2-aminoacetophenone (2-AA); 4-methylquinazoline; thiosulfonate; thiosulfinate; allicin; allyl sulfides; isopherone; α-isopherone; 1-octen-3-ol; 6-methyl-5-hepten-2-one; cathelicidin-2; formaldehyde; organophosphates; trichlorfon; malathion; dichlorvos; formalin; azamethiphos; pyrethrum; carbaryl; diflubenzuron; deltamethrin; hydrogen peroxide; garlic; mustard; rosemary; lavender; bog myrtle; clove; nutmeg; cinnamon; basil; bay leaf; thyme; calamus; Canada wild ginger; tarragon; an oil, emulsion, aqueous solution, or aqueous slurry thereof; and combinations thereof.

According to another example (“Example 19”), further to Examples 1-18, the aquatic environment is a saltwater environment.

According to another example (“Example 20”), a containment pen for containing an aquatic organism in an aquatic environment, the containment pen includes a support structure, a net coupled to the support structure to define an enclosure for containing the aquatic organism, and a treatment reservoir system operatively associated with the enclosure of the containment pen and configured for controlled release of a treatment compound in the aquatic environment to reduce a presence of an aquatic parasite in the enclosure, the treatment reservoir system comprising at least one treatment reservoir of any one of Example 1-18.

According to another example (“Example 21”), further to Example 20, the at least one treatment reservoir is a point source reservoir disposed proximal to the enclosure or within the enclosure, a delivery bladder container disposed proximal to the enclosure or within the enclosure, a perimeter reservoir at least partially encircling the enclosure, a horizontally-oriented reservoir, a vertically-oriented reservoir, or a combination thereof.

According to another example (“Example 22”), further to Example 20 or Example 21, the aquatic environment is a saltwater environment.

According to another example (“Example 23”), an aquatic organism containment system for containing aquatic organisms in an aquatic environment, the system includes a plurality of containment pens of Example 20 or Example 21, and an anchoring system for maintaining a relative position of the plurality of containment pens to define a containment pen array within a containment site.

According to another example (“Example 24”), further to Example 23, the aquatic environment is a saltwater environment.

According to another example (“Example 25”), a method for controlling an aquatic parasite includes positioning one or more treatment reservoirs of any one of Examples 1-19 in operative proximity with or within an aquaculture containment pen.

According to another example (“Example 26”), further to Example 25, the aquatic parasite is sea lice.

According to another example (“Example 27”), further to Example 25 or Example 26, the aquaculture containment pen contains salmon.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a schematic illustration of a perspective view of a system including a plurality of containment pens in an array and having one or more treatment reservoirs according to some embodiments;

FIG. 2A is a schematic illustration of a perspective view of a containment pen according to some embodiments;

FIG. 2B is a schematic illustration of a perspective view of another containment pen according to some embodiments;

FIG. 3A is a schematic illustration of a perspective view of a treatment reservoir having a horizontal configuration and at least one port according to some embodiments;

FIG. 3B is a schematic illustration of a perspective view of a treatment reservoir having a vertical configuration and at least one port according to some embodiments;

FIG. 3C is a schematic illustration of a perspective view of a treatment reservoir having a buoy configuration and at least one port according to some embodiments;

FIG. 3D is a schematic illustration of a perspective view of a delivery bladder container according to some embodiments;

FIG. 3E is an exploded view of the embodiment depicted in FIG. 3D;

FIG. 3F is a schematic illustration of a containment site having treatment reservoirs including a treatment reservoir for releasing a baiting or deterrent compound according to some embodiments;

FIG. 4A is a photograph of an inner surface of a port having a housing, a membrane, and a seal according to some embodiments;

FIG. 4B is a photograph of an outer surface opposing the inner surface of the port of FIG. 4A;

FIG. 4C is a photograph of an inner surface of another port having a housing, a membrane, and a seal according to some embodiments;

FIG. 4D is a photograph of an outer surface opposing the inner surface of the port of FIG. 4C;

FIG. 4E is a photograph of an inner surface of yet another port having a housing, a membrane, and a seal according to some embodiments;

FIG. 4F is a photograph of an outer surface opposing the inner surface of the port of FIG. 4E;

FIG. 5A is a scanning electron microscope (SEM) micrograph of a porous media according to some embodiments;

FIG. 5B is a scanning electron microscope (SEM) micrograph of a porous media with a semi-permeable coating thereon according to some embodiments;

FIG. 6 is a schematic illustration of a top view of a treatment reservoir configured as a point source reservoir for treatment of an aquatic environment according to some embodiments;

FIG. 7 is a schematic illustration of a top view of a treatment reservoir configured as a perimeter reservoir for treatment of an aquatic environment according to some embodiments;

FIG. 8 is a schematic illustration of a perspective view of a horizontally-oriented set of treatment reservoirs for treating a containment pen array in an aquatic environment according to some embodiments;

FIG. 9 is a schematic illustration of a perspective view of a vertically-oriented treatment reservoirs for treating a containment pen array in an aquatic environment according to some embodiments; and

FIG. 10 is a schematic illustration of atop view of a set of embodiments for treatment reservoirs treating a containment pen array in an aquatic environment, the reservoirs being offset from anchoring infrastructure, according to some embodiments.

Persons skilled in the art will readily appreciate that various aspects of the present disclosure can be realized by any number of methods and apparatus configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

### DETAILED DESCRIPTION

### Definitions

This disclosure is not meant to be read in a restrictive manner. For example, the terminology used in the application should be read broadly in the context of the meaning those in the field would attribute such terminology.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “treatment reservoir” as used herein in the context of aquaculture, or fish farming, is a source for delivering compounds for aquatic environment treatment. Fish farming involves the selective breeding of fish, either in fresh water or sea water, with the purpose of producing a food source for consumption. The term “treatment reservoir” may be referred to herein as “treatment reservoir for delivering compounds for aquatic environment treatment” or to as simply “reservoir”.

The term “supporting structure” as used herein in the context of aquaculture includes walkways, hand rails, bird nets, feed lines, containment pens, and other known aquaculture infrastructure.

The term “containment pen” as used herein is meant to denote a supporting structure, moorings, as well as a net or cage attached thereto to define an enclosure in which aquatic organisms are confined. Containment pens may also include camera systems, feeding lights, and laser units.

The term “containment site” as used herein is meant to denote a natural or artificial barrier defining an area in which at least one containment pen and at least one treatment reservoir are disposed for the treatment of aquatic organisms or aquatic animals within the containment site.

The term “brackish water” as used herein is water that has more salinity than fresh water but less salinity than seawater.

### DISCUSSION

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Various inventive concepts disclosed herein relate to systems, reservoirs, and associated methods including aquatic environment treatment features. In various examples, the systems, reservoirs, and methods relate to configurations for effective treatment of a desired aquatic environment. Although various features and advantages are described, additional or alternative features and advantages are contemplated and will become apparent upon a review of this disclosure.

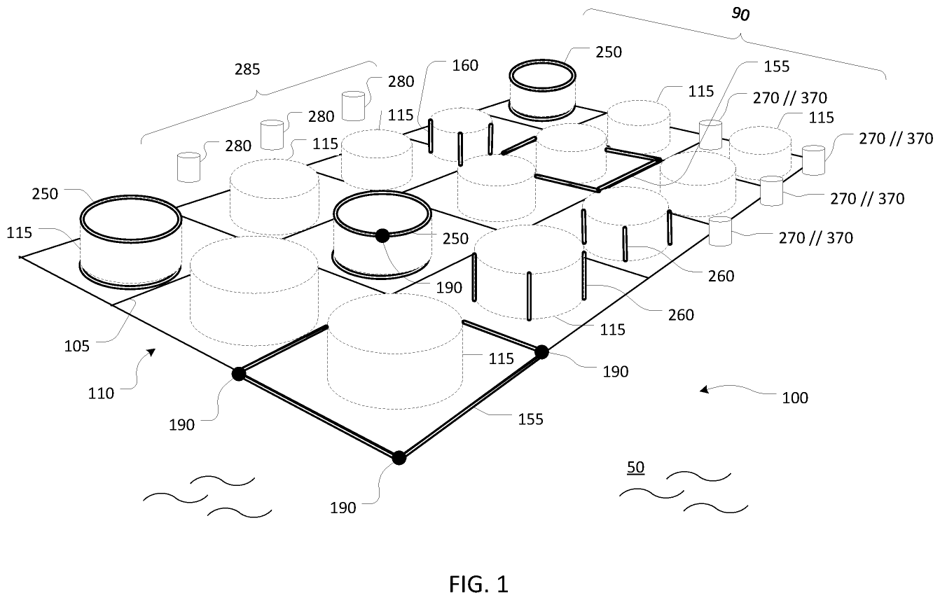

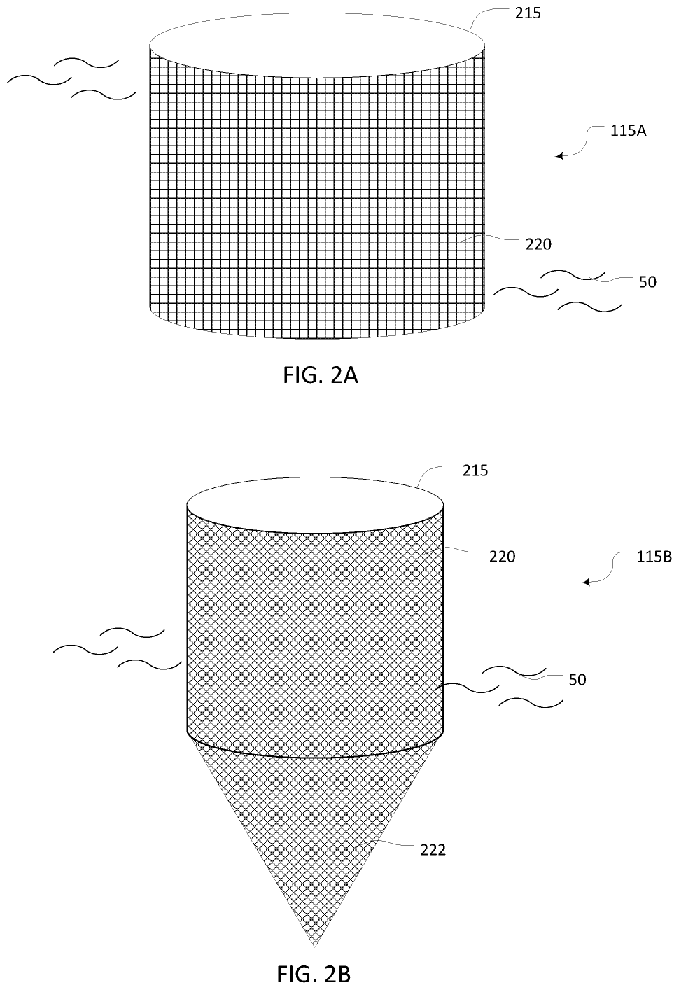

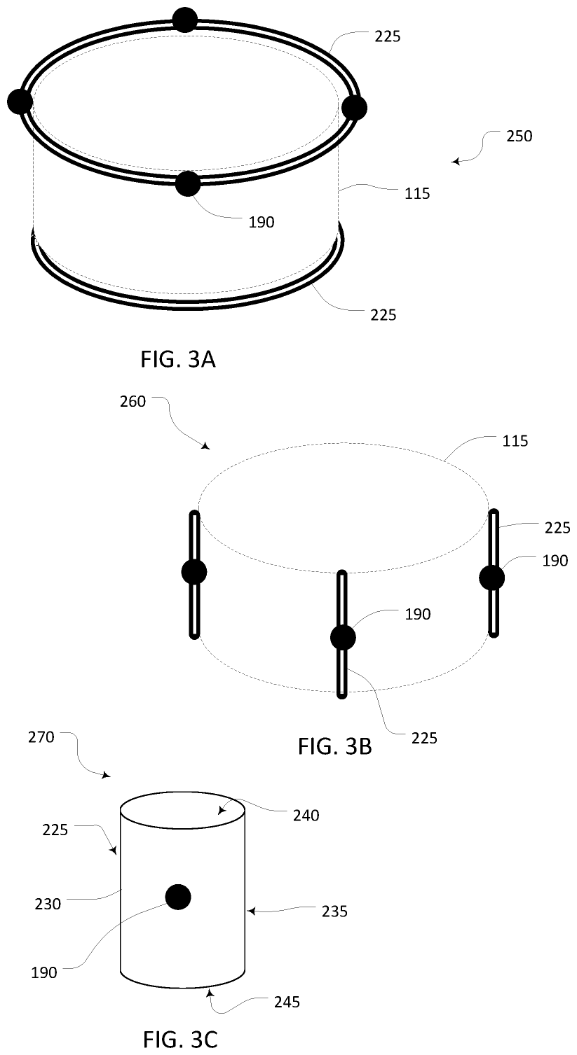

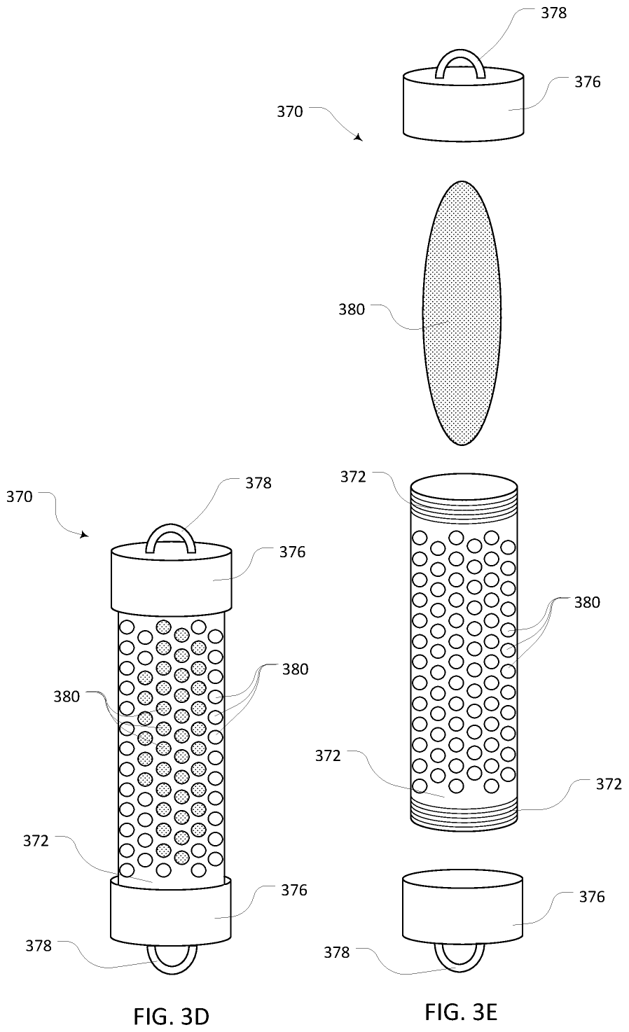

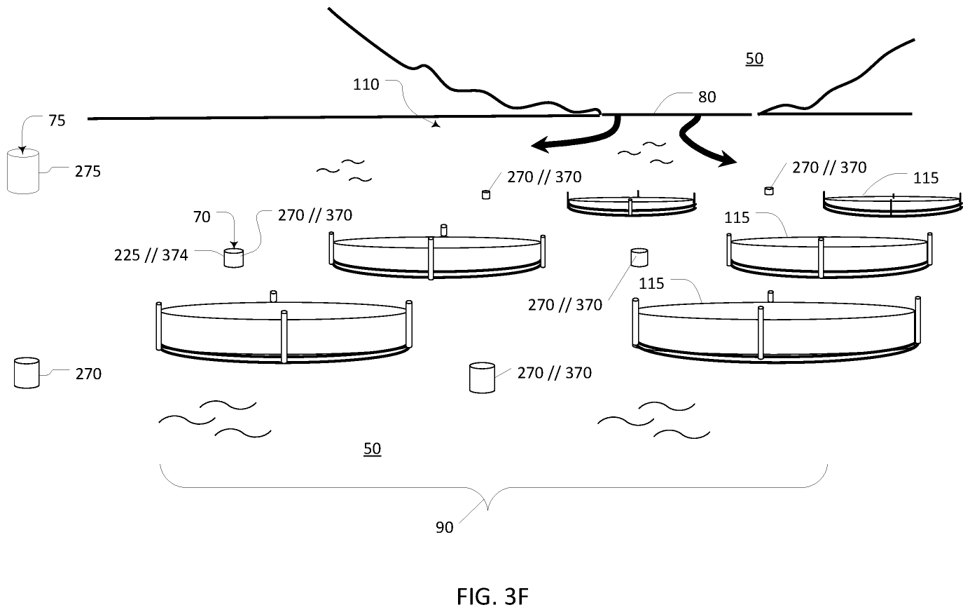

FIG. 1 is a perspective view illustration of an aquatic system 100 for a containment site 110, including a plurality of containment pens 115 in an array in aquatic environment 50. Containment site 110 may be secured in an aquatic environment with an anchoring system 105 for maintaining a relative position of the plurality of containment pens 115 to define a containment pen array 90. Aquatic system 100 also includes one or more treatment reservoirs 250, 260, 270, 280, and/or 370, which may take on any of a variety of configurations described herein. In general, the treatment reservoir includes a treatment compound and a delivery apparatus (e.g., delivery apparatus 225 as shown in FIGS. 3A-3D) configured to release the treatment compound according to a desired release profile. For example, at least one treatment reservoir may be configured as a horizontally-oriented reservoir 250 attached to or positioned around a containment pen 115, a horizontally-oriented reservoir 155 attached to anchor system 105, a vertically-oriented reservoir 260 attached to or positioned adjacent to a containment pen 115, a point source reservoir 270 at least partially disposed in or positioned near a containment site 110 or a containment pen 115, a perimeter reservoir 280 such as a buoy reservoir 280 or series of buoy reservoirs 285 at least partially encircling a containment site 110 or containment pen 115, a delivery bladder container 370 at least partially disposed in or positioned near a containment site 110 or a containment pen 115, or combinations of any of the foregoing as described with reference to FIGS. 2-10. The delivery apparatuses of the treatment reservoirs of any of the foregoing configurations may include one or more ports 190 at one or more desired positions on the delivery apparatus, or a delivery bladder positioned within the delivery apparatus for delivering a treatment compound from a respective reservoir. Any combination of configurations is contemplated fora single reservoir, or from reservoir-to-reservoir as desired.

FIG. 2A depicts a containment pen 115A that includes a support structure 215 coupled to a net 220 for containing one or more aquatic organisms or aquatic animals in an aquatic environment 50. Net 220 can be configured into various shapes such as the cylindrical shape depicted in FIG. 2A or, alternatively, net 220 may include a rounded or cone shaped portion 222 as depicted in FIG. 2B.

Any suitable shape for the containment pens 115 may be used in addition to containment pens 115A and 115B depicted in FIGS. 2A and 2B respectively. Shapes such as tetrahedron, square pyramid, hexagonal pyramid, cube, cubic, cuboid, triangular prism, octahedron, pentagonal prism, hexagonal prism, dodecahedron, sphere, ellipsoid, icosahedron, cone, cylinder, ribbon, and other geometric or non-geometric structures are also contemplated. Aquatic environment 50 is flowable in, though, and around the containment pen 115A, which may reside in a larger body of liquid (e.g., water, saltwater, or brackish water). Support structure 215 may be formed of a cage or frame that is floatable in the aquatic environment 50. In some embodiments, the support structure 215 is rigid. Any support structure suitable in existing aquaculture net pens may be used, such as, but not limited to a pen, cage, frame, or net made or steel and/or plastic or other suitable materials as known in the art for aquatic environments and aquaculture. Net 220 may be any known netting useful for aquaculture net pens. Containment pen 115A defines an enclosure for the aquatic animals (e.g., fish) or aquatic organisms and may be open at the top provided that the net 220 extends at least to the surface of the aquatic environment 50, or a sufficient height above the surface of the aquatic environment 50 so that the aquatic animals or other aquatic organisms being contained therein are not easily able to get out. Containment pens also can be closed and submerged in high energy locations or submerged through storms—in this case the aquatic organisms are contained by cage or netting on all sides.

In some embodiments, the treatment reservoir is attached (i.e., fastened) to standard aquaculture infrastructure. In such embodiments, treatment reservoirs of the present disclosure can easily be integrated into current aquaculture systems. For example, in some embodiments, containment pen 115A may include a treatment reservoir positioned within the containment pen 115A by attaching the treatment reservoir to, for example: an aquaculture video camera and/or sensor system or its associated infrastructure, such as a buoy or it's connecting chain; or a dedicated buoy and/or its connecting chain. In some embodiments, it is desirable to minimize interference with fish maintained in the containment pen, and thus the treatment reservoir is attached to existing aquaculture infrastructure within the containment pen to avoid the need for additional retention means (e.g., buoys and/or connecting chains). In other embodiments, the treatment reservoir is positioned external to (e.g., adjacent) the containment pen 115A. When positioned external to the containment pen 115A, the treatment reservoir is positioned so that the treatment compound to be released from the treatment reservoir has its desired effect. In some embodiments, the treatment reservoir is positioned external to the containment pen 115A by attaching the treatment reservoir to, for example: a marker buoy and/or its associated connecting chain; a grid or mooring buoy and/or its associated connecting chain; a grid or mooring line (i.e., anchoring system 105); or a dedicated buoy and/or its connecting chain.

The containment pen 115B depicted in FIG. 2B includes a support structure 215, and further to those features of containment pen 115A, a cone shaped portion 222, and a mesh or net 220 coupled to the support structure 215 and cone shaped portion 222 to define an enclosure for containing the aquatic animals or aquatic organisms. One example of the aquatic animals or aquatic organisms is a fish; for ease of discussion only, “fish” will be used throughout the disclosure, and is meant to denote any aquatic animal or aquatic organism. The containment pen 1158, or simply the “pen” as used interchangeably herein, is provided as an example of various pen features, including a more tapered, or cone shaped bottom net structure 222. Such differences, among others in pen shape and size will be readily appreciated by those in the field.

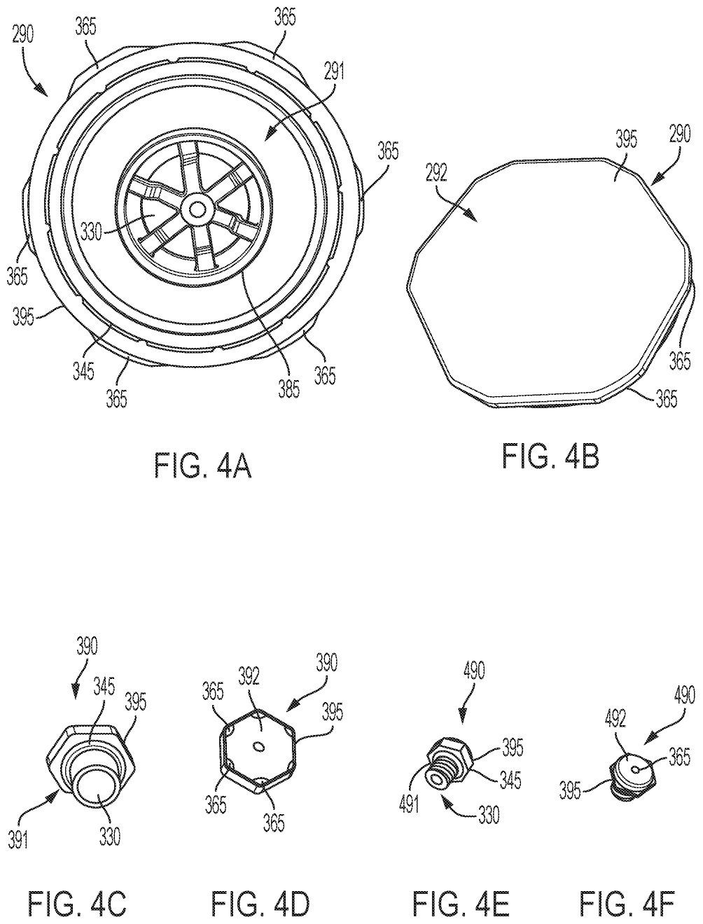

FIGS. 3A-3E depict illustrations of treatment reservoirs of various configurations. For instance, FIG. 3A is an illustration of a treatment reservoir 250 that has a horizontal configuration, similar to the horizontally oriented reservoir 250 of FIG. 1. For example, the treatment reservoir 250 can include a delivery apparatus 225 configured as a continuous, or segmented circumferential tubular structure with one or more ports 190 therein. As depicted, treatment reservoir 250 includes a delivery apparatus 225 with a treatment compound therein (not shown). Delivery apparatus 225 of treatment reservoir 250 is configured to release the treatment compound according to a desired release profile. For example, the treatment reservoir 250 may include at least one port 190 associated with the delivery apparatus 225, as shown schematically in FIG. 3A. Ports 190 may be disposed anywhere along the delivery apparatus 225 and may be a unitary part of the delivery apparatus itself or a separate component attached thereto. Ports 190 will be discussed in more detail in relation to FIGS. 4A-4F. Treatment reservoir 250 may be configured so that the delivery apparatus 225 is positioned adjacent to a containment pen 115 as shown in FIG. 3A so as to be positioned in close proximity but without adding the load of the delivery apparatus 225 having the treatment compound therein to the containment pen 115. Alternatively, delivery apparatus 225 may be attached to or positioned within a containment pen 115 (not shown).

FIG. 3B is an illustration of a treatment reservoir 260 that has a vertical configuration and at least one port 190. For example, the treatment reservoir 260 can include a delivery apparatus 225 configured as a continuous or segmented vertical tubular structure, or containers with one or more ports 190 similar to those referenced above with regard to FIG. 3A and a treatment compound therein (not shown). Delivery apparatus 225 of treatment reservoir 260 is configured to release the treatment compound according to a desired release profile. Port 190 may be disposed anywhere along the delivery apparatus 225 and may be a unitary part of the delivery apparatus itself or a separate component attached thereto. In various examples, the delivery apparatus 225 includes a housing or container capable of retaining the treatment compound with the port attached to and accessing the interior of the housing in which the treatment compound is contained. The delivery apparatus 225 can be a tube, pipe, barrel, box, or other shape container with one or more associated ports for delivering the treatment compound. Treatment reservoir 260 may be configured so that the delivery apparatus 225 is positioned adjacent to a containment pen 115 as shown in FIG. 3B or may be attached to or positioned within a containment pen 115 (not shown).

FIG. 3C depicts a treatment reservoir 270 having a buoy configuration that has at least one port 190. A buoy configuration is a point source with floatation such that treatment reservoir 270 is held in position. Treatment reservoir 270 includes a delivery apparatus 225 and a treatment compound (not illustrated). Delivery apparatus 225 of treatment reservoir 270 is configured to release the treatment compound according to a desired release profile. Delivery apparatus 225 may include a container 230 having at least one port 190. Port 190 may be disposed within the container body 235 of delivery apparatus 225 or may be disposed at the top 240 or bottom 245 (not shown) of the delivery apparatus 225. Treatment reservoir 270 may be of any size or shape suitable for containing treatment compound for delivery to an aquatic environment.

FIG. 3D depicts a delivery bladder container 370 having an outer containment vessel 372, a delivery bladder 374 disposed within containment vessel 372 (dotted fill), end caps 376, and attachment device 378. FIG. 3E depicts an exploded view of the delivery bladder container 370, having an outer containment vessel 372, a delivery bladder 374, end caps 376, and attachment device 378. As used herein, a “delivery bladder container” is a type of treatment reservoir, and a “delivery bladder” is a type of delivery apparatus. Referring to FIGS. 3D and 3E, the outer containment vessel 372 includes a plurality of openings 380. The openings of the plurality of openings 380 can be of any shape, such as, for example, circular, elliptical, square, rectangular, irregular, or a combination thereof. The number and size of openings of the plurality of openings 380 are selected such that liquid of the aquatic environment can move in and out of the outer containment vessel 372 with minimal resistance while preventing large debris (e.g., driftwood) from entering the outer containment vessel 372 and animals (e.g., birds, seals, sharks, fish, etc.) from contacting the delivery bladder 374 disposed within the containment vessel 372. In some embodiments, and as depicted the outer containment vessel 372 of FIG. 3E, the ends of the containment vessel 372 include a threaded section 382. Threaded section 382 is configured to interact with a threaded section on an inner surface of each of end caps 376 and secure end caps 376 to outer containment vessel 372. Other means for securing end caps 376 to containment vessel 372 are also contemplated, including, for example, welds, compression fittings, adhesives including epoxy adhesive, couplings, friction fit or snap-fit components, etc. As depicted, attachment device 378 form a loop on each one of end caps 376. However, attachment device 378 may be disposed on or in the end caps 376, the outer containment vessel 372, or both the end caps 376 and the outer containment vessel 372. Attachment devices 378 provide a contact point for securing delivery bladder container 370 in position, and can take any suitable form such as, for example a loop, hook, eye hook, or hole. A rope, chain, shackle, carabiner, etc. may be affixed to the delivery bladder container 370 via the attachment device 378 to secure delivery bladder container 370 in a desired position. For example, the delivery bladder container 370 can be affixed or attached to an aquaculture video camera and/or sensor system or its associated infrastructure, such as a marker buoy and/or its associated connecting chain; a grid or mooring buoy and/or its associated connecting chain; a grid or mooring line (i.e., anchoring system 105); or a dedicated buoy and/or its connecting chain.

The delivery bladder container 370 can be cylindrical, as depicted in FIGS. 3D and 3E, or may be, for example, spherical, cuboidal, conical, or a rectangular prism. Outer containment vessel 372 and end caps 376 can be made from, for example, plastics (e.g., polyvinyl chloride) and stainless steel. The material of the outer containment vessel 372 can be selected to provide sufficient strength to withstand environmental factors likely to be encountered by the deliver bladder container 370, such as, for example, salt water, tidal forces, waves, UV light exposure, etc., and withstand other factors such as attack or inspection by animals such as birds, seals, sharks, fish, etc.

In some embodiments, one or both end caps 376 form a part of, or are otherwise permanently integrated with, outer containment vessel 372. For example, in some embodiments the delivery bladder container is a rectangular prism having continuous (i.e., non-removable) sides. In such embodiments, access to an interior of the outer containment vessel may be achieve by a hatch or other similar securable opening. This allows for the delivery bladder 374 to be positioned within the outer containment vessel 372. In another example, and referring to FIGS. 3D and 3E, one end cap 376 is permanently affixed to outer containment vessel 372 while the opposite end cap 376 configured to be removable from outer containment vessel 372.

Delivery bladder 374 is made from a release media and is configured to be filled with a treatment compound 70 (not shown). The delivery bladder 374 is configured to release the treatment compound 70 according to a desired release profile. Further details concerning the release media, treatment compound, and release profile(s) are provided elsewhere herein. In some embodiments, the delivery bladder is a tube, formed from the release media. Each end of the tube can be closed and secured (i.e., sealed), thereby forming a bladder and retaining the treatment compound within delivery bladder 374. The tube may be cylindrical with a consistent diameter over the majority of the length of the bladder, or may have a larger diameter towards the middle of the bladder (e.g., a football-shaped bladder). In other embodiments, the delivery bladder 374 is an injectable bladder, wherein the delivery bladder 374 is a continuous bag without an opening. In such embodiments, the injectable bladder is filled with the treatment compound using, for example a syringe, where the syringe passes through the release media of the delivery bladder 374 and the treatment compound is deposited within the delivery bladder 374.

FIG. 3F is an illustration of a containment site 110 having treatment reservoirs 270 and/or deliver bladder containers 370 for releasing treatment compound 70 to the aquatic environment 50 and further including one or more baiting reservoirs 275 for releasing a treatment compound in the form of a baiting compound 75. Containment site 110 may be located at an inlet or a bay or other body of water (natural or man-made) and may include an opening 80 to an adjacent aquatic environment 50 (e.g., open ocean). The array 90 of containment pens 115 may be treated by point source reservoirs 270 and/or delivery bladder containers 370 positioned in and/or around the array 90. The point source reservoirs 270 may include delivery apparatus 225 and treatment compound 70 therein, while the delivery bladder containers 370 may include delivery bladder 374 and treatment compound 70 therein.

While point source reservoirs 270 and delivery bladder containers 370 are depicted in FIG. 3F, horizontally or vertically oriented treatment reservoirs (e.g., 250, 260, respectively) may additionally or alternatively be utilized in the containment site 110 of FIG. 3D. Baiting reservoir 275 includes a delivery apparatus 225 (such as a buoy-type delivery apparatus) and a treatment compound 75 therein that is specifically a baiting compound. Baiting reservoir 275 may be positioned a distance away from an array 90 of containment pens 115 so that release of the baiting compound 75 from the baiting reservoir 275 lures, or baits undesirable organisms (e.g., predators, parasites, or the like) away from the array 90 thus providing an alternative or additional manner of protecting the fish located within the containment pens 115.

As previously referenced, delivery apparatuses 225 (e.g., FIGS. 3A-3C) may be configured as a tube (e.g., FIGS. 3A-3B) or container (e.g., FIG. 3C) that is either completely or partially enclosed. In some embodiments, the port(s) may be the only opening(s) in the delivery apparatuses 225 such that, once the delivery apparatuses 225 are filled with treatment compound, the delivery apparatuses 225 are utilized to permit release of the treatment compound around and/or into the containment pens 115. In some embodiments, the container portions of the delivery apparatuses 225 (tube, body, top, or bottom, for example) may be made of plastic, metal, or other known material compatible in an aquaculture environment.

Referring back to FIG. 3C, the delivery apparatus 225 may be formed as a container, such as the container 230, which is shown as having a port 190. The container 230 stores or contains the treatment compound that is releasable through the port 190. Port 190 includes a release media (not depicted), which is described in detail below. In addition to shape, the permeability and/or porosity properties of the release media forming at least a portion of the port 190 of the delivery apparatus 225 may be varied as desired to achieve a desired delivery, release, or treatment profile.

One or more portions of the delivery apparatus 225 (e.g., the ports 190) or of the delivery bladder 374 of the delivery bladder container 370 may have porous, semi-porous, permeable, or semi-permeable properties to permit a treatment compound (e.g., an aqueous solution, aqueous slurry, oil, or emulsion) to flow in and/or out of the delivery apparatus 225 or delivery bladder 374. In some embodiments, the porous, semi-porous, permeable, or semi-permeable material included in the ports 190 of the delivery apparatus 225 or that makes up the delivery bladder 374 is at least one release media chosen from a fluoropolymer, a polyethylene, an expanded polyethylene, a microporous polyethylene, a polypropylene, polyvinylidene fluoride (PVDF), polyurethane (PU), nylon, polytetrafluoroethylene (PTFE), expanded ePTFE, nitrocellulose, polyethersulfone, a metal matrix composite, a frit, a ceramic matrix, and combinations thereof.

The release media may be a porous material, semi-porous material, permeable material, semi-permeable material, or a combination thereof, that allows flow in a first direction flowing from within the treatment reservoir or delivery bladder towards the aquatic environment located externally relative to the treatment reservoir or delivery bladder. If desired, the release media may optionally allow flow in the opposite direction, in other words, in a second direction flowing from the aquatic environment toward the inside of the treatment reservoir.

The release media may be selected to preferentially allow flow or partial flow in either direction and may be selected to prevent or allow certain organisms or impurities from flowing through the port or into the delivery bladder. In various examples, the port or delivery bladder is configured such that the treatment compound is released in a controlled manner from the port (e.g., according to a desired time of release and/or release rate) or delivery bladder and flows into the aquatic environment. At least initially, the aquatic environment has a concentration of treatment compound lower than the that of the aqueous solution, aqueous slurry, oil, or emulsion contained within treatment reservoir. In some embodiments, the aquatic environment is saltwater, although a variety of aquatic environments (e.g., freshwater, saltwater, or brackish water) are contemplated.

Although expanded polyethylene and microporous polyethylene membranes, including expanded or microporous polyethylene membranes of polyethylene terephthalate (PET), high-density polyethylene (HDPE), ultra-high molecular weight polyethylene (UHMWPE) and low-density polyethylene (LDPE), may be a particularly advantageous material for the release media, the release media may be formed from a variety of materials, such as, but not limited to expanded polytetrafluoroethylene (ePTFE), polyvinyl chloride (PVC), polypropylene (PP), polystyrene (PS), and others.

In some examples, the release media includes a thermoplastic polymer as one or more layers or coatings on the release media to achieve a temperature dependent treatment compound release profile. Generally, thermoplastic polymers soften above certain temperatures and then reharden upon cooling. Some examples of suitable thermoplastic polymers that may be employed include at least one of polyethylene, polypropylene, polyvinyl chloride, polystyrene, polybenzimidazole acrylic, nylon, polytetrafluoroethylene, poly(ethene-co-tetrafluoroethene) (ETFE), polyvinylidene difluoride (PVDF), polychlorotrifluoroethylene (PCTFE), fluorinated ethylene propylene (FEP), perfluoroalkoxy (PFA), polyurethane (PUR and PU), a nitrocellulose (NC), which may include a mixture of inert cellulose nitrate and cellulose acetate polymers, a polyethersulfone, and combinations thereof. Examples of a polyester used in at least portions of the ports 190 of the delivery apparatus 225 or of the delivery bladder 374 may include at least one release media chosen from terephthalic acid (PTA), dimethyl ester dimethyl terephthalate (DMT), monoethylene glycol (MEG), and combinations thereof.

Although various examples of suitable materials have been provided, in at least some embodiments, the release media includes a fluoropolymer as one or more layers or coatings on the release media. Examples of suitable fluoropolymers include poly(ethene-co-tetrafluoroethene) (ETFE), polyvinylidene difluoride (PVDF), polychlorotrifluoroethylene (PCTFE), fluorinated ethylene propylene (FEP), and combinations thereof. Fluoropolymers are made from monomers chosen from perfluorocycloalkene (PFCA), ethylene (Ethane) (E), vinyl fluoride (fluoroethylene) (VF1), vinylidene fluoride (1,1-difluoroethylene) (VDF or VF2), tetrafluoroethylene (TFE), chlorotrifluoroethylene (CTFE), propylene (P), hexafluoropropylene (HFP), perfluoropropylvinylether (PPVE), perfluoromethylvinylether (PMVE), and combinations thereof.

In a non-limiting example, the release media is an expanded polyethylene or a microporous polyethylene. In another non-limiting example, the release media is an expanded fluoropolymer and/or microporous fluoropolymer, such as expanded polytetrafluoroethylene (ePTFE). The release media may take on a variety of forms, including at least one of tubes, fibers, mesh, membranes, sheets, and combinations thereof. The release media may be a 2-dimensional structure, a 3-dimensional structure, or combinations thereof.

One or more portions of the delivery apparatus 225 or delivery bladder 374 may be configured such that treatment compound flow passes preferentially in a direction from the delivery apparatus 225 or delivery bladder 374 to an area external to the delivery apparatus 225 or delivery bladder 374. For example, treatment compound is releasable from the container 230 (as shown in FIG. 3C) and may flow through port 190 through a release media (not shown), and into the aquatic environment external to the treatment reservoir 270. Similarly, treatment compound is releasable from the delivery bladder 374 into the space between the delivery bladder 374 and outer containment vessel 372. Water from the aquatic environment, which passes relatively freely in and out of the outer containment vessel via the plurality of openings 380, dilutes the released treatment compound and carries it from the delivery bladder container 370.

Suitable ports 190 of the delivery apparatus 225 may be configured as diffusion ports, vent ports, or other types of ports as desired. Non-limiting examples of various sizes and configurations of ports (290, 390, 490) are shown in FIGS. 4A-4E. Ports include a release media (such as those described herein) operatively associated with the port to control the release of the treatment compound through the port according to a desired release profile.

FIG. 4A illustrates an inner surface 291 of a port 290 having a housing 395, a release media 330, and a seal 345 according to some embodiments. Release media 330 includes at least one material layer for allowing delivery of a treatment compound through a port of a delivery apparatus to an aquatic environment. The release media 330 may be a membrane, a film, a composite having two of more layers of membrane and/or film, or combinations thereof. Release media 330 may include an area that is about the same as the area of a housing in some embodiments. In addition, the release media 330 may include one or more material layers, and the material layers may be the same or different. Port 290 further includes at least one release vent 365 disposed along a circumference of housing 395. The positioning and number of release vents 365 may be varied to achieve the desired release profile. While port 290 shown in FIG. 4A includes threads 385 for attaching the port 290 to a delivery apparatus 225, other mechanical attachment methods are contemplated such as, for example, a weld, a dispensed gasket, snap-fit or friction fit components, as well as chemical attachment methods using adhesives, glues, resins, and the like for connecting the port 290 to the delivery apparatus 225. FIG. 4B illustrates an outer surface 292 opposing the inner surface 291 of port 290 of FIG. 4A. In this view, the housing 395 is shown with the placement of release vents 365 evenly spaced around the perimeter of the housing 395.

FIG. 4C illustrates an inner surface 391 of another port 390 having a housing 395, a release media 330, and a seal 345 in accordance with some embodiments. FIG. 4D illustrates an outer surface 392 opposing the inner surface 391 of port 390 of FIG. 4C. In the embodiment depicted in FIG. 4D, release vents 365 of port 390 are disposed around the circumference of the housing 395 on the outer surface 392.

FIG. 4E illustrates an inner surface 491 of yet another port 490 having a housing 395, a release media 330, and a seal 345. A smaller port such as port 490 may also have one or more release vents 365. FIG. 4F illustrates an outer surface 492 opposing the inner surface 491 of port 490 of FIG. 4E. In FIGS. 4E-4F, release vent 365 of port 490 is disposed at the center of the housing 395. In the embodiment depicted in FIG. 4F, the release vent of port 490 has thereon an optional protective surface cover 492.

The treatment compound 70 is at least one chosen from a semiochemical compound, an antiparasitic compound, a masking compound, a baiting compound, and combinations thereof. The treatment compound is dilutable in fresh water, saltwater, or brackish water. Compounds including semiochemical compounds, antiparasitic compounds, masking compounds, baiting compounds, and combinations thereof may be useful as treatment compounds. In some embodiments, the semiochemical compound may be a non-host derived semiochemical compound chosen from 2-aminoacetophenone (2-AA), 4-methylquinazoline, deterrents, masking compounds, thiosulfonate, thiosulfinate, allicin, allyl sulfides, and combinations thereof. In some embodiments, the baiting compound may be chosen from a host derived semiochemical including, but not limited to, isopherone or α-isopherone, 1-octen-3-ol, 6-methyl-5-hepten-2-one, cathelicidin-2, (i.e., compounds found in salmon conditioned water), trout conditioned water compounds, and combinations thereof. Other compounds contemplated include, but are not limited to, an antiparasitic compound chosen from formaldehyde, organophosphates, trichlorfon, malathion, dichlorvos, formalin, azamethiphos, pyrethrum, carbaryl, diflubenzuron, deltamethrin, hydrogen peroxide, and combinations thereof.

An appropriate treatment compound can be selected to target a chosen parasite or predator, or a group thereof. For example, for the parasite Lepeophtheirus spp. and Caligus spp. (i.e., sea lice), suitable deterrent/repellent compounds may include compounds derived from garlic, glucosinolates (e.g., mustard), 2-AA (2-aminoacetophenone) and 4-methylquinazoline, as well as compounds derived from rosemary, lavender, bog myrtle, clove, nutmeg, cinnamon, basil, bay leaf, thyme, calamus, Canada wild ginger, tarragon, for example, as well as combinations of any of the foregoing. In some embodiments where the target parasite is sea lice, the treatment compound is at least one compound or compound derivative chosen from 2-aminoacetophenone (2-AA), 4-methylquinazoline, thiosulfonate, thiosulfinate, allicin, allyl sulfides, isopherone, α-isopherone, 1-octen-3-ol, 6-methyl-5-hepten-2-one, cathelicidin-2, formaldehyde, organophosphates, trichlorfon, malathion, dichlorvos, formalin, azamethiphos, pyrethrum, carbaryl, diflubenzuron, deltamethrin, hydrogen peroxide, garlic, glucosinolates (e.g., mustard), rosemary, lavender, bog myrtle, clove, nutmeg, cinnamon, basil, bay leaf, thyme, calamus, Canada wild ginger, tarragon, and combinations thereof.

While sea lice are common issue in salmon aquaculture, an appropriate treatment compound can similarly be selected and incorporated into the described treatment reservoirs, systems, and methods for use in aquaculture involving other species, or to target parasites other than sea lice. For example, in addition to salmon aquaculture, the treatment reservoirs, systems, and methods described herein can be used in the aquaculture of catfish, tilapia, carp, cod, trout, seaweeds, shrimp, clams, oysters, mussels, and scallops, amongst others. Target parasites include, but are not limited to: protistans such as Amyloodinium ocellatum, Ichthyobodo necator, Trypanosoma spp., Trypanoplasma spp., Paramoeba [=Neoparamoeba] perurans, Acanthamoeba, Naegleria, Protacanthamoeba, Rhogostoma, Vannella, Vermamoeba, Trichodina spp., Uronema spp., Epistylis spp., Ichthyophthirius multifiliis, Cryptocaryon irritans, Perkinsus marinus, Bonamia ostreae, Bonamia exitiosa, Marteilia spp., and Aggregata spp.; myxozoans such as Tetracapsuloides bryosalmonae, Myxobolus cerebralis, Ceratonova [=Ceratomyxa] shasta, Kudoa spp., Parvicapsula spp., Enteromyxum spp., Sphaerospora [=Polysporoplasma] sparis, Sphaerospora [=Leptotheca] sparidarum, Carassius auratus, Chloromyxum spp., Thelohanellus hovorkai, and Henneguya spp.; monogeneans such as Benedenia seriolae, Cichlidogyrus spp., Dactylogyrus spp., Diplectanum aequans, Diplozoon spp., Gyrodactylus spp., Lamellodiscus spp., Microcotyle spp., Neobenedenia melleni, Sparicotyle chrysophrii, and Zeuxapta seriolae; digeneans such as Prosorhynchus epinepheli, Prosorhynchus pacificus, Helicometra fasciata, Erilepturus hamate, Transversotrema patialense, Didymocystis spp., Unitubulotestis sardae, Sarda sarda, Didymocylindrus simplex, Katsuwonus pelamis, Galactosomum spp., Stephanostomum tenue, Cardicola spp., Sparus aurata, Thunnus spp., Paradeontacylix spp., Seriola dumerili, Psettarium spp., Bolbophorus damnificus, Ictalurus punctatus, Diplostomum spathaceum, Tylodelphys spp., Posthhodiplostomum cuticula, Cryptocotyle lingua, Centrocestus formosanus, Clinostomum spp., Proctoeces spp., Himashtla spp. Stephanostomum spp., and Microphallus spp.; cestodes such as Diphyllobothrium spp., Eubothrium spp., Gilquinia squall, Monobothrium wageneri, Tinca tinca, Triaenophorus crassus, Schyzocotyle [=Bothriocephalus] acheilognathi, Hepatoxylon trichiurid, Thunnus thynnus, Tylocephalum spp., Proteocephalus spp.; Khawia spp.; and arthropods such as Arugulus foliaceus, Ergasilus sieboldin, Lernaea cyprinacea, Salmincola salmoneus, Lepeophtheirus salmonis, Caligus elongatus, Caligus rogercresseyi, L. salmonis, Lernaeocera branchialis, Gadus morhua, Lernanthropus kroyeri, Lernanthropus kroyeri, Dicentrarchus labrax, Diergasilus kasahara, Ergasilus lobus, Ergasilus lizae, Alitropus typus, Ceratothoa gaudichaudii, Ceratothoa oestroides, C. parallela, Cirolana fluviatilis, Emetha audouini, Nerocila orbignyi, Natatolana borealis, Modiolicola gracilicaudus, Myicola ostreae, Mytilicola intestinalis, Mytilicola orientalis, Ostrincola koe, Pectenophilus ornatus, Edotia doellojuradoi, Nepinnotheres novaezelandiae, and Orbione bonnieri. In certain embodiments, the treatment reservoirs, systems, and methods described herein can be used in multitrophic aquaculture, including integrated multitrophic aquaculture. In such embodiments, the treatment compound can be selected to target one or more parasites of one or more species being farmed or otherwise grown in proximity with one another.

In some embodiments, the treatment compound is included or otherwise incorporated into an aqueous solution or slurry. The concentration of the treatment compound in the aqueous solution or slurry can be selected to allow for efficient diffusion of the treatment compound through or across the release media. In other embodiments, the treatment compound is an oil, or is included in an emulsion.

Using the treatment reservoirs disclosed herein to deliver a treatment compound at or near an aquaculture pen or site can delay or prevent the need for a traditional parasite treatment of the affected fish, and/or increase the time between treatments. The constant, controlled release of the treatment compound may lower, for example, the transmission of sea lice to or from other fish passing by the pens of the aquaculture site (e.g., wild fish). The treatment compound may confuse and/or repel parasites such as sea lice from hosts. Sea lice at the infective copepodid stage have a short viability window of about three to ten days for attaching to their host, and can thus be controlled by preventing or reducing population growth of the lice in the aquaculture pens resulting from successful host attachment and mating. This allows for an overall reduction in traditional anti-parasitic treatments, improved treatment effectiveness, and/or allows for the efficacy of existing treatment methods to be maintained. The controlled release of the treatment compounds as provided herein can lower fish mortality through reduced handling and stress, minimize outbreaks of disease resulting from stress, and increase weight gain per unit time, as every treatment starvation day that may be eliminated will result in greater weight gain and/or faster growth to harvest.

The release rate may range from about 0 g/m²/day to about 1,000,000 g/m²/day, from about 10 g/m²/day to about 500,000 g/m²/day, from about 10 g/m²/day to about 100,000 g/m²/day, from about 10 g/m²/day to about 50,000 g/m²/day, from about 10 g/m²/day to about 10,000 g/m²/day, from about 50 g/m²/day to about 1000 g/m²/day, from about 60 g/m²/day to about 900 g/m²/day, from about 70 g/m²/day to about 800 g/m²/day, from about 80 g/m²/day to about 700 g/m²/day, from about 90 g/m²/day to about 600 g/m²/day, or from about 100 g/m²/day to about 500 g/m²/day. Additionally, the release rate may range from about 10 g/m²/day to about 100 g/m²/day, from about 100 g/m²/day to about 200 g/m²/day, from about 200 g/m²/day to about 300 g/m²/day, from about 300 g/m²/day to about 400 g/m²/day, from about 400 g/m²/day to about 500 g/m²/day, from about 500 g/m²/day to about 600 g/m²/day, from about 600 g/m²/day to about 700 g/m²/day, from about 700 g/m²/day to about 800 g/m²/day, from about 800 g/m²/day to about 900 g/m²/day, or from about 900 g/m²/day to about 1000 g/m²/day. It is to be appreciated that any range from about 0 g/m²/day to about 1,000,000 g/m²/day is contemplated.

The release media may be at least one chosen from porous, semi-porous, permeable, or semi-permeable materials. The release rate may be specific to the release media chosen. Other examples include release media where more than one layer of material is used, such as, for example, a composite having a porous membrane, such as a microporous or expanded polyethylene membrane, with a coating thereon, such as a second polyethylene or a polyurethane, to achieve a desired release profile. Additionally, release media thickness and porosity may also be tailored to alter release rate to achieve the desired release profile. An effective release profile may correspond to an effective concentration of the treatment compound in the aquatic environment being released over a period of time. For example, a treatment reservoir or delivery bladder container associated with a polyethylene membrane as a release media may provide for controlled release at an effective release rate for a time of about 30 days, about 120 days, about 300 days, about 365 days, about 550 days, about 730 days, in some embodiments, the time is from about 30 days to about 750 days, or from about 120 days to about 550 days.

It will be recognized that a preferred release profile will depend on, for example, the application and environmental factors, and can be controlled by, for example, the permeation rate of the release media, the volume of treatment compound in the release container (e.g., in the release bladder), and the size and shape of the release container. In certain applications, it may be desirable to release a higher volume of treatment compound over a shorter amount of time to achieve higher concentrations, for example, while in others, it may be desirable to release a steady (and lower) volume of treatment compound over a greater time period to achieve a sustained concentration of the treatment compound over time. Low concentrations over a short period of time and high concentrations over a longer period of time can also be achieved. Environmental factors such as local flow dynamics (e.g., tide, currents, etc.) will also affect the desired release profile in a particular situation, and must be accounted for in how they may affect local concentrations of the treatment compound. Those of skill in the art can identify a desired release profile for a given application, which can be affected by, for example, the life cycle of the target parasite, effective concentrations of target compound against a target parasite, etc. The release profile can be controlled by, for example, selecting a release media with an appropriate permeation rate, sizing the surface area of the release media (e.g., volume and/or shape of a release bladder), and controlling the volume of treatment compound.

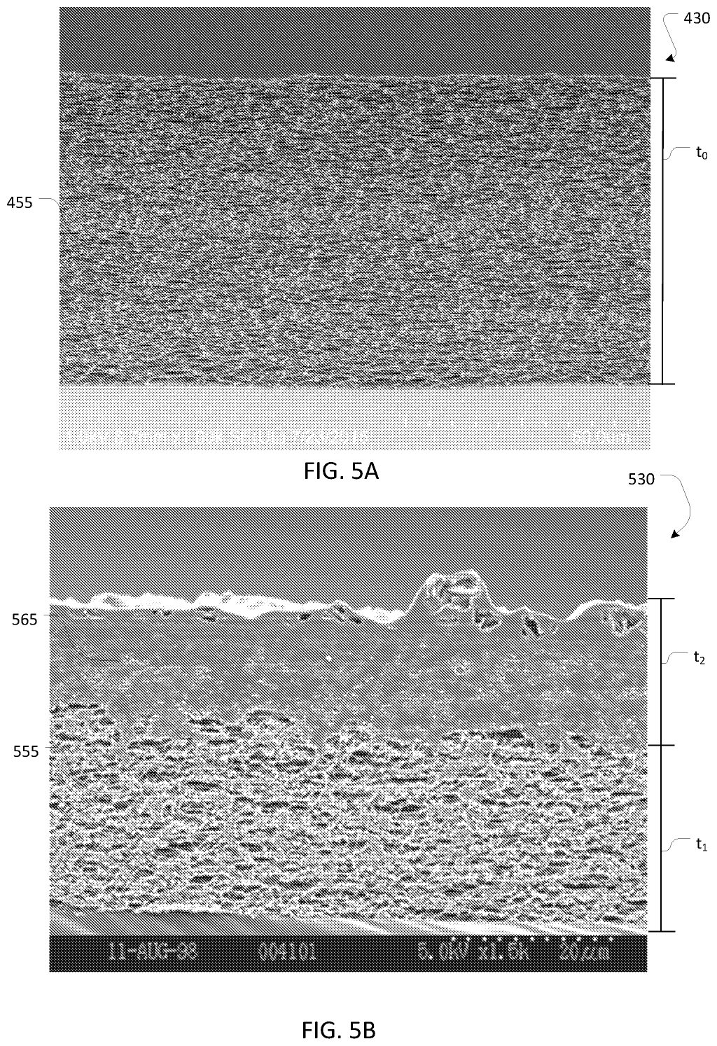

FIG. 5A is a scanning electron microscope (SEM) micrograph of a release media 430 according to some embodiments. The release media 430 shown in FIG. 5A is an ePTFE membrane 455 having a thickness to. FIG. 5B is a scanning electron microscope (SEM) micrograph of a release media 530 as a composite that includes a porous material 555 having a first thickness t₁ and a semi-permeable coating material 565 having a second thickness t₂. In the example of the release media 530 of FIG. 5B, porous material 555 is an ePTFE membrane having a thickness of about 35 μm, and semi-permeable coating material 565 is a polyurethane (PU) coating having a thickness of about 12 μm. A porous material may have a thickness of less than 5 μm, about 5 μm, about 10 μm, about 15 μm, about 20 μm, about 25 μm, about 30 μm, about 35 μm, about 40 μm, about 45 μm, about 50 μm, about 75 μm, about 100 μm, about 150 μm, or about 200 μm, in some embodiments, the porous material has a thickness from about 5 μm to about 200 μm. A semi-permeable material may have a thickness of less than 5 μm, about 5 μm, about 10 μm, about 15 μm, about 20 μm, about 25 μm, about 30 μm, about 35 μm, about 40 μm, about 45 μm, about 50 μm, about 75 μm, about 100 μm, about 150 μm, or about 200 μm, in some embodiments, the semi-permeable material has a thickness from about 5 μm to about 200 μm.

An appropriate release media can be selected to provide a desired release profile. It will be recognized that factors including material chosen, coatings, pore size, hydrophobicity, oleophobicity, and overall surface area of the release media will affect the release profile. The release profile will also depend on the desired treatment compound, and can be affected by, for example, the surface tension and viscosity of the treatment compound. Altering or otherwise affecting one or more of these factors will affect the release profile of the release media. For example, depending on the material chosen, a treatment compound may diffuse though a solid dialysis membrane, through pores present in the release membrane, or wet the release membrane and then release through to the other side. In addition to these intrinsic factors of the release media, extrinsic factors such as tides, currents, etc. will further affect the release profile of the release media. Those of skill in the art, with the benefit of the instant disclosure, will be able to select a release media having the appropriate surface area to produce a delivery apparatus 225 or delivery bladder 374 having a desired release profile.

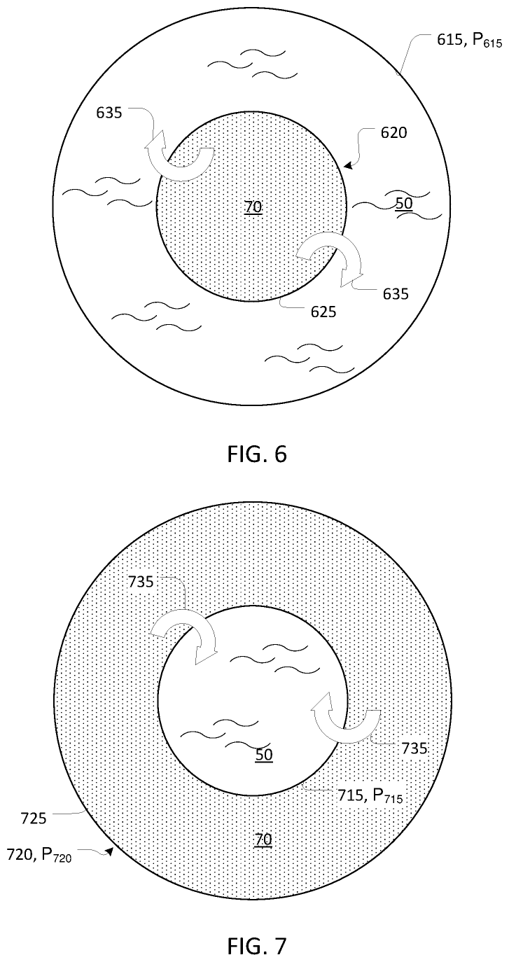

FIG. 6 is a diagram illustrating a point source reservoir providing treatment to a desired aquatic area 615 (e.g., such as an area adjacent to and/or including an area inside of a containment pen 115 (e.g., pen 115 of FIG. 1). Aquatic area 615 has a perimeter P₆₁₅ that represents an area suitable for aquatic organisms and contains an aquatic environment 50 therein, e.g. water, saltwater, or brackish water. Perimeter P₆₁₅ may be within a greater area defining a containment site 110 (not shown). Treatment reservoirs treating the aquatic environment may also be positioned outside of the containment pen(s) with water currents delivering treatment compounds of value in and around the containment site as illustrated by treatment reservoirs 270 as in FIG. 3F. As with the treatment reservoirs described above (e.g., the treatment reservoir 250, 260, 270, and delivery bladder container 370 as depicted in FIGS. 3A-3E), treatment reservoir 620 includes a delivery apparatus 625 and a treatment compound 70 therein. Treatment reservoir 620 is fluidly associated with aquatic area 615 and configured for controlled release of a treatment compound 70 flowing from reservoir 620 to the aquatic environment 50 in area 615 in the direction of the flow arrows 635 to reduce the presence of an aquatic parasite in the aquatic area 615. In some embodiments, delivery apparatus 625 includes a port having a release media, or a delivery bladder comprised of a release media, such as described above. In various embodiments, the release media that facilitates controlled release is a fluoropolymer, such as ePTFE, and/or a semi-permeable material such as polyethylene or polyurethane, although a variety of release media are contemplated. In various embodiments, the reservoir/aquatic area arrangement as shown in FIG. 6 may be expanded to include point source reservoirs arranged around and within an array of containment pens such as is illustrated in FIG. 3F.

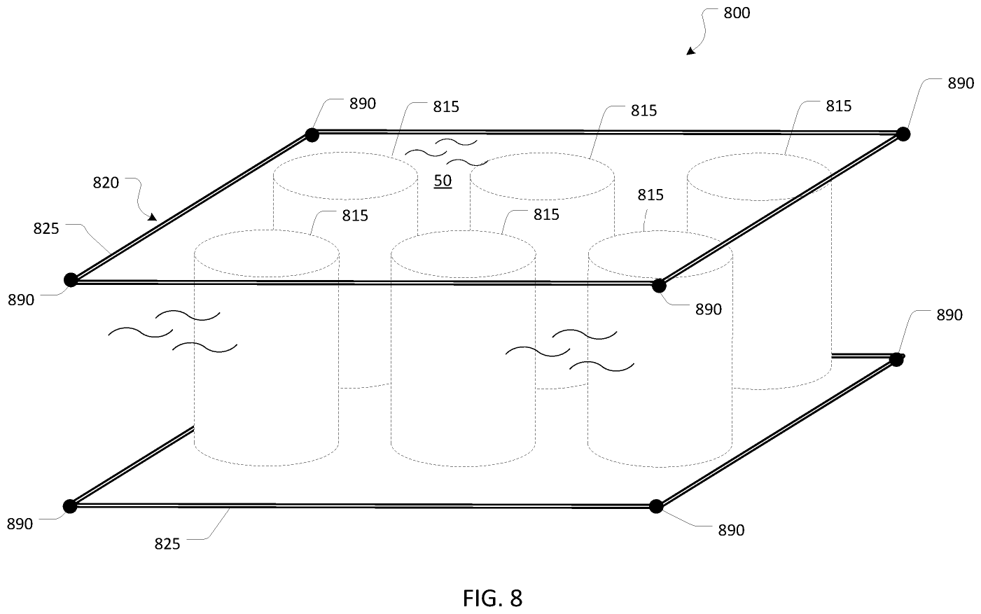

FIG. 7 is a top view diagram illustrating a perimeter reservoir providing treatment to a desired aquatic area 715 (e.g., such as an area adjacent to and/or including an area inside of a containment pen 115 (e.g., pen 115 of FIG. 1). Treatment reservoir 720 has perimeter P₇₂₀. Perimeter P₇₂₀ may be within a greater area defining a containment site 110 (not shown). In the example shown in FIG. 7, treatment reservoir 720 surrounds aquatic area 715 having perimeter P₇₁₅. As with the treatment reservoirs described above (e.g., the treatment reservoir 250, 260, and 270 as shown in FIGS. 3A-3C or the treatment reservoir 620 of FIG. 6), treatment reservoir 720 includes a delivery apparatus 725 and a treatment compound 70 therein. Treatment reservoir 720 is fluidly associated with aquatic area 715 and is configured for the controlled release of a treatment compound 70 flowing from treatment reservoir 720 to the aquatic environment 50 in area 715 to reduce the presence of an aquatic parasite in the area 715. In some embodiments, delivery apparatus 725 includes a port having a release media, such as described above. In some embodiments, delivery apparatus 725 is operatively associated with a release media such for a delivery apparatus and a treatment compound. The treatment compound 70 contained in treatment reservoir 720 may be a solution and is dilutable in a liquid such as water, saltwater, or brackish water. Treatment compound 70 flows in the direction of the flow arrows 735 in FIG. 7 showing the flow of treatment compound into the area 715 from treatment reservoir 720. In various embodiments, the reservoir/aquatic area arrangement as shown in FIG. 7 may be expanded to an array of containment pens having at least one perimeter reservoir surrounding the array.

FIG. 8 is a perspective view illustration of a treatment reservoir system 800 configured as a horizontally-oriented reservoir 820 in accordance with at least one embodiment. Horizontally-oriented treatment reservoir 820 may be configured to be proximate and/or around one or more containment pens 815 suitable for containing aquatic organisms in an aquatic environment 50. In the example of FIG. 8, the containment site 110 (not shown) includes an area greater than the horizontally-oriented treatment reservoir 820 and the containment pens 815. In some embodiments, treatment reservoir 820 is operatively associated with a delivery apparatus 825 and a treatment compound 70 contained therein. The delivery apparatus 825 may further include one or more ports 890. In some embodiments, delivery apparatus and/or the one or more ports 890 are formed of a material chosen from the release media suitable for delivery apparatus and/or ports as described above. The treatment compound 70 is disposed within and/or is diffusible through a release media, or ports 890 or ports 290, 390, and 490 as shown in FIGS. 4A-4F. Delivery apparatus 825 may include a tube or tubing as shown in FIG. 8 and/or may include a series of diffusion ports 890 fixed to or attached to a non-permeable tube. While tubing is shown in FIG. 8, the delivery apparatus may be any suitable configuration. In some embodiments, the form of delivery apparatus and/or port material is chosen from at least one of a membrane, a laminate, a composite, a sheet, a tube, a fiber, a coating, and combinations thereof.

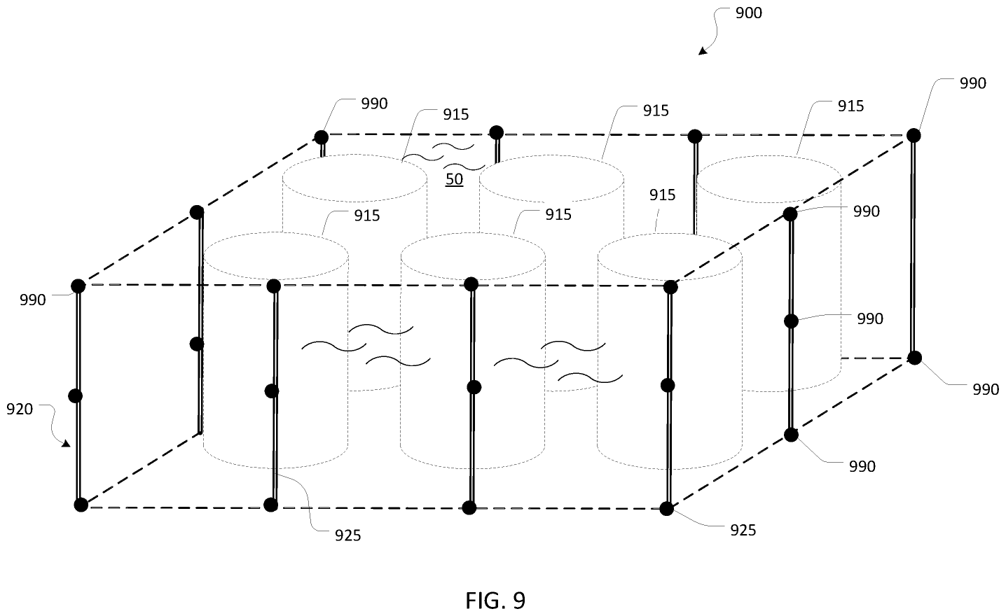

FIG. 9 is a perspective view illustration of a treatment reservoir system 900 configured as a vertically-oriented reservoir 920 in accordance with at least one embodiment. Vertically-oriented treatment reservoir 920 may be configured to be proximate and/or around one or more containment pens 915 suitable for containing aquatic organisms in an aquatic environment 50. In the example of FIG. 9, containment site 110 (not shown) includes an area greater than the vertically-oriented treatment reservoir 920 and the containment pens 915. In embodiments, treatment reservoir 920 is operatively associated with a delivery apparatus 925 and a treatment compound 70 contained therein. The delivery apparatus 925 may further include one or more ports 990. In some embodiments, delivery apparatus and/or the one or more ports 990 are formed of a material chosen from the release media suitable for delivery apparatus and/or ports as described above. The treatment compound 70 is disposed within and/or is diffusible through the release media of the delivery apparatus 925 or any of the ports 990, the release media of which is chosen from any of those described above. Delivery apparatus 925 may include a tube or tubing as shown in FIG. 9 and/or may include a series of diffusion ports 990 fixed to or attached to a non-permeable tube of delivery apparatus 925. While tubing is shown in FIG. 9, the delivery apparatus may be any suitable configuration as described above.

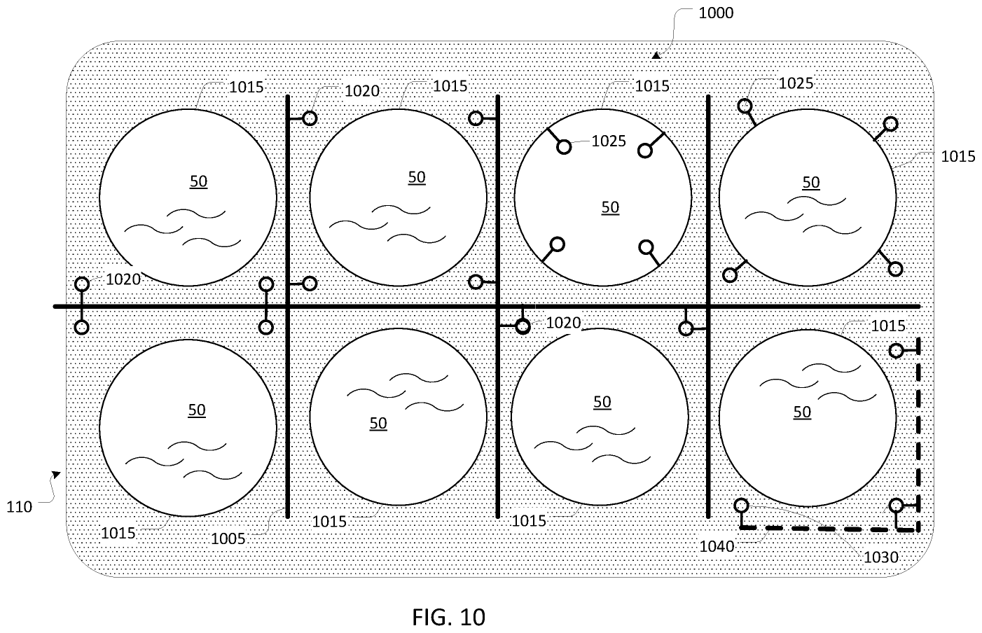

FIG. 10 is a top view illustration of another vertically-oriented reservoir system 1000, the vertically-oriented treatment reservoir(s) 1020 being attached and/or offset from aquaculture anchoring infrastructure, in accordance with at least one embodiment. Vertically-oriented treatment reservoir 1020, which may be in a containment site 110 suitable for an aquatic environment (e.g. open water such as lake or ocean), may be anchored via anchors in several ways. Treatment reservoirs 1020 may be attached directly to an aquaculture farm support structure 1005. Alternatively, treatment reservoirs 1025 may be attached directly to containment pens 1015, either internally or externally relative to the pen. In another example, treatment reservoirs 1030 may be attached to a predator cage 1040 or other aquaculture structure. Vertically-oriented treatment reservoirs 1020, 1025, and/or 1030) may be configured to be proximate and/or around one or more containment pens 1015 suitable for containing aquatic organisms in an aquatic environment 50. The treatment compound 70 is disposed within or diffusible through a delivery apparatus, which may be similar to the any of the delivery apparatuses shown in FIGS. 1-9, or otherwise described above.

FIGS. 11A and 11B—system positioning and individual attachment.

The features of any of the embodiments previously described, including those described in association with FIGS. 1-11 may be combined or substituted for one another as desired. In any of the embodiments as in FIGS. 1-11, the at least one treatment reservoir may include a combination of treatment reservoirs as described herein. In any of the embodiments as in FIGS. 1-11, the at least one treatment reservoir may include a delivery apparatus operatively associated with a port including a release media to controllably release the treatment compound according to a desired release profile.

In any of the embodiments as in FIGS. 1-11, the treatment reservoir may be configured to exhibit a release rate of the treatment compound selected based upon time in the environment, temperature of the environment, salinity of the environment, or combinations thereof.

### Examples

Membranes

The membranes described in Table 1 were used in the Experimental Examples provided below.

TABLE 1

| | | Mass | | | | |
|---|---|---|---|---|---|---|
| | | per | | | Bubble | Source/ |
| Membrane | Microporous | area | Thickness | Porosity | Point | prepared |
| No. | Membrane | (g/M²) | (μm) | (%) | (psi)[kPA] | according to |
| 1 | Expanded | 28 | 28 | | 11 [75.8 kPa] | U.S. Pat. No. 3,953,566 |
| | PTFE with | | | | | to R. W. Gore |
| | hydrophilic | | | | | |
| | coating | | | | | |
| 2 | Polyethylene | 4 | 11 | 65 | 150 [1034 kPa] | Gel |
| | | | | | | processed |
| | | | | | | polyethylene |
| | | | | | | membrane |
| 3 | Expanded | 20 | 47 | 75-80 | 28.2 [194.6 kPa] | U.S. Pat. No. 3,953,566 |
| | PTFE | | | | | to R. W. Gore |
| 4 | Expanded | | | | | U.S. Pat. No. 3,953,566 |
| | PTFE with | | | | | to Gore, R. W. and |
| | polyurethane | | | | | U.S. Pat. No. 4,194,041 |
| | coating | | | | | to Gore et al. |

Expanded polytetrafluoroethylene membranes (ePTFE) Nos. 1, 3, and 4 were prepared according to the general teachings of U.S. Pat. No. 3,953,566 to Gore. ePTFE membrane No. 1 further comprises a hydrophilic PVA coating. Methods to apply a PVA coating to ePTFE are known in the art (see for example, J P2001000844 A2 to Bessho et al.). ePTFE membrane No. 4 further comprises a polyurethane coating (see U.S. Pat. No. 4,194,041 to Gore et al.). The microporous polyethylene membrane No. 2 is a gel processed polyethylene membrane.

### Experimental Example 1

A 2 ml auto sampler vial was filled with a treatment compound, the semiochemical garlic oil. The vial was covered with a silicone/PTFE septum screw top.

Before the screw top was secured onto the vial, the septum was removed and replaced with membranes or composite films according to Samples 1-3 as in Table 2. Sample 1 was a membrane of porous ePTFE (membrane No. 3 of Table 1). Sample 2 was a composite film including porous ePTFE membrane with a semipermeable PU coating (membrane No. 4 of Table 1) similar to that depicted in FIG. 5, with the porous ePTFE exposed to the contents of the vial. Sample 3 was a semipermeable PU layer and a porous PTFE membrane layer, with the semipermeable PU layer exposed to the contents of the vial.

The vial was placed within a 500 ml glass jar filled with 400 ml H₂O. The jar containing the vial and the water surrounding the vial was then placed on an orbital shaker table running at 150 rpms. Water samples were taken initially, at 24 hours, and at 48 hours and the concentration of garlic oil in the water was measured using a UV spectrophotometer, an Agilent Cary 60 UV-Vis Spectrophotometer, Santa Clara, Calif., USA. Concentration versus time was plotted for each Sample 1-3. Release rates were calculated based on that data are presented in Table 2.

TABLE 2

| | | Rate |
|---|---|---|
| Sample | Membrane | g/m²/day |
| 1 | Porous ePTFE (membrane No. 3 of Table 1) | 368 |
| 2 | Composite: | 235 |
| | Porous ePTFE membrane/Semipermeable PU | |
| | coating (membrane No. 4 of Table 1) | |
| | (semipermeable membrane away from garlic in vial) | |
| 3 | Composite: | 111 |
| | Semipermeable PU/Porous ePTFE (membrane No. 4 | |
| | of Table 1) (semipermeable membrane towards | |
| | garlic in vial) | |

### Experimental Example 2

A 10 ml screw-top plastic container having 0.25 inch (6.35 mm) holes drilled in its sides was fitted with a bladder of microporous gel processed polyethylene (PE) (membrane No. 2 of Table 1), porous expanded polytetrafluoroethylene (ePTFE) with a hydrophilic coating (membrane No. 1 of Table 1), ePTFE (membrane No. 3 of Table 1), or ePTFE membrane with a semipermeable PU coating (membrane No. 4 of Table 1), and filled with either garlic oil or 2-aminoacetophenone (2-AA). The bladder was maintained in the container, with the container sealed with a screw top. The assembly was placed into a 2 L glass jar containing approximately 1.5 L of deionized water and put on a shaker table at 150 rpm. Water samples were retrieved at various time points, and the concentration of either garlic oil or 2-AA was measured by UV spectroscopy. Permeation rates were calculated for each membrane, and are presented in Table 3.

### Experimental Example 3

Plastic vials were filled with either garlic oil or 2-AA and sealed with lids fitted with vents formed from porous membranes of methylcellulose (MEC) (Pall Corp., GN-6 Metricel 0.45 micron 25 mm) or polyether sulfone (PES) (Pall Corp., Supor 0.1 micron 25 mm PES disk). Vials were placed in glass jars filled with 400 ml deionized water and placed on a shaker table at 150 rpm. Water samples were retrieved at various time points, and the concentration of either garlic oil or 2-AA was measured by UV spectroscopy. Permeation rates were calculated for each membrane, and are presented in Table 2.

TABLE 2
Permeation rates of various release membranes.

| | | Permeation |
|---|---|---|
| Membrane | Chemical | g/m² Day |
| Microporous | Garlic oil | 275.1592357 |
| Polyethylene | | |
| Microporous ePTFE | Garlic oil | 576.1146497 |
| (membrane No. 1) | | |
| Microporous ePTFE | 2-AA | 5735.350318 |
| (membrane No. 1) | | |
| Microporous ePTFE | Garlic oil | 1233.528662 |
| (membrane No. 3) | | |
| Microporous ePTFE | Garlic oil | 375.0318471 |
| with polyurethane | | |
| coating | | |
| (membrane No. 4) | | |
| MEC | Garlic oil | 39.42802548 |
| PES | Garlic oil | 25.38343949 |

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A treatment reservoir for delivering a treatment compound to an aquatic environment, the treatment reservoir comprising:
a treatment compound; and
a delivery apparatus configured to release the treatment compound according to a desired release profile, wherein the delivery apparatus is operatively associated with the treatment compound and is configured to release the treatment compound to the aquatic environment according to a desired release profile.

2. The treatment reservoir of claim 1, wherein the delivery apparatus includes a release media configured to release the treatment compound from the delivery apparatus to the aquatic environment according to the desired release profile.

3. The treatment reservoir of claim 2, wherein the release media is in a form selected from a membrane, a sheet, a tube, a bladder, a fiber, a coating, and a combination thereof.

4. The treatment reservoir of claim 2, wherein the release media comprises at least one of a fluoropolymer, a polyethylene, a polypropylene, polyvinylidene fluoride, polyurethane, nylon, nitrocellulose, and polyethersulfone.

5. The treatment reservoir of claim 2, wherein the release media comprises a microporous polyethylene and/or an expanded polyethylene.

6. The treatment reservoir of claim 4, wherein the fluoropolymer is an expanded polytetrafluoroethylene (ePTFE).

7. The treatment reservoir of claim 2, wherein the release media further comprises at least one coating.

8. The treatment reservoir of claim 7, wherein the at least one coating is semi-permeable.

9. The treatment reservoir of claim 7, wherein the at least one coating includes at least one thermoplastic polymer, at least one fluoropolymer, or a combination thereof.

10. The treatment reservoir of claim 9, wherein the at least one thermoplastic polymer is selected from: polyethylene, polypropylene, polyvinyl chloride, polystyrene, polybenzimidazole acrylic, nylon, polytetrafluoroethylene (PTFE), poly(ethene-co-tetrafluoroethene) (ETFE), polyvinylidene difluoride (PVDF), polychlorotrifluoroethylene (PCTFE), fluorinated ethylene propylene (FEP), perfluoroalkoxy (PFA), polyurethane (PUR), a nitrocellulose (NC), a polyethersulfone, and combinations thereof; and
the at least one fluoropolymer is selected from: poly(ethene-co-tetrafluoroethene) (ETFE), polytetrafluoroethylene (PTFE), polyvinylidene difluoride (PVDF), polychlorotrifluoroethylene (PCTFE), fluorinated ethylene propylene (FEP), and combinations thereof.

11. The treatment reservoir of claim 2, wherein the delivery apparatus comprises a container having at least one port, wherein the container contains the treatment compound and the at least one port includes the release media.

12. The treatment reservoir of claim 2, further comprising an outer containment vessel configured to retain the delivery apparatus, wherein the outer containment vessel includes a plurality of openings and the delivery apparatus comprises a delivery bladder at least partially formed from the release media.

13. The treatment reservoir of claim 12, wherein the delivery bladder is a sealable tube or an injectable bladder.

14. The treatment reservoir of claim 12, wherein the outer containment vessel is cylindrical and includes an end cap at each end of the cylindrical containment vessel, wherein each end cap is configured to engage the outer containment vessel.

15. The treatment reservoir of claim 12, further comprising one or more attachment devices configured to retain the outer containment vessel in position.

16. The treatment reservoir of claim 2, wherein the treatment compound is diffusible through the release media.

17. The treatment reservoir of claim 1, wherein the treatment compound is selected from a semiochemical compound, an antiparasitic compound, a masking compound, a baiting compound, and combinations thereof.

18. The treatment reservoir of claim 1, wherein the treatment compound is selected from: 2-aminoacetophenone (2-AA); 4-methylquinazoline; thiosulfonate; thiosulfinate; allicin; allyl sulfides; isopherone; α-isopherone; 1-octen-3-ol; 6-methyl-5-hepten-2-one; cathelicidin-2; formaldehyde; organophosphates; trichlorfon; malathion; dichlorvos; formalin; azamethiphos; pyrethrum; carbaryl; diflubenzuron; deltamethrin; hydrogen peroxide; garlic; mustard; rosemary; lavender; bog myrtle; clove; nutmeg; cinnamon; basil; bay leaf; thyme; calamus; Canada wild ginger; tarragon; an oil, emulsion, aqueous solution, or aqueous slurry thereof; and combinations thereof.

19. The treatment reservoir of claim 1, wherein the aquatic environment is a saltwater environment.

20. A containment pen for containing an aquatic organism in an aquatic environment, the containment pen comprising:
a support structure;
a net coupled to the support structure to define an enclosure for containing the aquatic organism; and
a treatment reservoir system operatively associated with the enclosure of the containment pen and configured for controlled release of a treatment compound in the aquatic environment to reduce a presence of an aquatic parasite in the enclosure, the treatment reservoir system comprising a treatment reservoir of claim 1.

21.-27. (canceled)
